(19) United States
(12) Patent Application Publication
(10) Pub. No.: US 2016/0299332 A1
(43) Pub. Date: Oct. 13, 2016

(54) PRE-RELEASE ENCAPSULATION OF ELECTROMECHANICAL SYSTEM DEVICES

(71) Applicant: QUALCOMM MEMS Technologies, Inc., San Diego, CA (US)

(72) Inventors: Tallis Young Chang, San Diego, CA (US); John Hyunchul Hong, San Clemente, CA (US); Yaoling Pan, San Diego, CA (US)

(21) Appl. No.: 14/682,588

(22) Filed: Apr. 9, 2015

(51) Int. Cl. G02B 26/00

(52) U.S. Cl. CPC G02B 26/001

(57) ABSTRACT

This disclosure provides systems, methods and apparatus for packaging an array of electromechanical systems (EMS) devices such as interferometric modulators (IMODs). In one aspect, a backplate including an aperture can be sealed to a substrate supporting an array of unreleased EMS devices to form a package. A release etch may be performed through the aperture after sealing the backplate to the substrate. By performing the release etch after sealing the backplate to the substrate, the effect on the array of EMS devices of the formation and outgassing of the sealant material can be reduced.

### TECHNICAL FIELD

This disclosure relates to the packaging of electromechanical systems and devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

### SUMMARY

The systems, methods and devices of this disclosure each have several innovative aspects, no single one of which is solely responsible for the desirable attributes disclosed herein.

One innovative aspect of the subject matter described in this disclosure can be implemented in a device, including a substrate, an array of interferometric modulators supported by a first surface of the substrate, a backplate sealed to the substrate by a first seal circumscribing the array of interferometric modulators to form a cavity surrounding the array of interferometric modulators, the backplate including at least one aperture extending through the backplate, and at least one cap overlying the at least one aperture in the backplate and sealed to the backplate by at least a second seal circumscribing the aperture.

In some implementations, the backplate can include a first surface facing the array of interferometric modulators and a second surface on the opposite side of the backplate as the first surface, and the cap can be sealed to the second surface of the backplate by the at least one second seal.

In some implementations, the backplate can include at least a second aperture extending through the backplate. In some further implementations, the at least one cap can extend over at least the first and second apertures extending through the backplate. In still further implementations, the second seal can circumscribe at least the first and second apertures extending through the backplate. In some other further implementations, the device can include at least a second cap overlying the second aperture extending through the backplate and sealed to the backplate by a third seal circumscribing the second aperture.

In some implementations, the cap can support a desiccant patch, and the desiccant patch can be aligned with the at least one aperture in the backplate. In some implementations, the first seal can include epoxy. In some implementations, the second seal can include metal or glass.

Another innovative aspect of the subject matter described in this disclosure can be implemented in a device, including a substrate, an array of interferometric modulators supported by a first surface of the substrate, a backplate sealed to the substrate by a first seal circumscribing the array of interferometric modulators to form a cavity surrounding the array of interferometric modulators, the backplate including means for introducing a release etchant into the cavity after sealing the backplate to the substrate, at least one cap overlying the introducing means, and means for sealing the cap to the backplate, the sealing means circumscribing the introducing means.

In some implementations, the introducing means can include at least one aperture extending through the backplate, and the sealing means can include at least a second seal, where the second seal circumscribes the aperture. In some implementations, the introducing means can include a plurality of apertures extending through the backplate. In some further implementations, the cap can overlie only one of the plurality of apertures, the sealing means can include at least a second seal, and the device can additionally include at least one additional cap overlying at least a second of the plurality of apertures extending through the backplate, and at least a third seal circumscribing at least the second of the plurality of apertures extending through the backplate. In some further implementations, the cap can overlie all of the plurality of apertures.

Another innovative aspect of the subject matter described in this disclosure can be implemented in a method of fabricating an EMS device, including forming an array of unreleased interferometric modulators supported by a first surface of a substrate, sealing a backplate to the substrate by a first seal circumscribing the array of interferometric modulators to form a cavity surrounding the array of interferometric modulators, the backplate including at least one aperture extending through the backplate, performing a release etch to release the array of interferometric modulators by introducing an etchant through the at least one aperture extending through the substrate, and sealing a cap to the backplate by a second seal to seal the at least one aperture extending through the substrate.

In some implementations, the backplate can include a ring of wetting material circumscribing the at least one aperture extending through the backplate, and sealing the cap to the backplate can include flowing a solder material onto the ring of wetting material. In some implementations, the first seal can include an epoxy material, and the method can additionally include curing the epoxy material of the first seal by exposing the epoxy material to heat prior to performing the release etch. In some implementations, the first seal can include an epoxy material, and the method can additionally include curing the epoxy material of the first seal by exposing the epoxy material to UV light prior to performing the release etch.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIGS. 3A and 3B are schematic exploded partial perspective views of a portion of an electromechanical systems (EMS) package including an array of EMS elements and a backplate.

FIG. 4 is a schematic cross-section view of an example of an EMS package including an array of interferometric modulators.

FIG. 5A is a schematic cross-section view of another example of an EMS package in which the backplate includes an aperture sealed by a cap.

FIG. 5B is a top plan view of the EMS package of FIG. 5A.

FIGS. 6A through 6C are schematic cross-sections of various stages in an example process for forming an etched backplate including an aperture.

FIGS. 7A through 7D are schematic cross-sections of various stages in an example process for forming an EMS package including an aperture sealed by a cap.

FIG. 8A is a top plan view of an example of a backplate with multiple apertures sealed by multiple caps.

FIG. 8B is a top plan view of an example of a backplate with multiple apertures sealed by a single cap.

FIG. 9A is a schematic cross-section of an example of an EMS package which includes a circuit board as a backplate, shown in a partially unassembled state.

FIG. 9B is a schematic cross-section of the EMS package of FIG. 9A, shown in an assembled state.

FIG. 10 is a flow diagram illustrating a fabrication process for an EMS package which utilizes a post-encapsulation release etch.

FIGS. 11A and 11B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

EMS devices such as interferometric modulators (IMODs) can be sealed in hermetic or near-hermetic packages to prevent accumulation of moisture and other contaminants which can contribute to stiction between a movable layer and an adjacent layer. Instead of packaging the EMS devices after one or more sacrificial layers have been removed by an etching process to release the movable layers of the EMS devices, a package can instead be formed prior to performing a release etch. In particular, a backplate having at least one aperture formed therein can be sealed to a substrate supporting one or more unreleased EMS devices. Because the EMS devices are unreleased, one or more sacrificial layers in the EMS devices will protect surfaces which will eventually be brought into and out of contact with one another. These surfaces which will eventually be brought into contact with one another will not be coated with outgassed material from the epoxy or other sealing material.

Particular implementations of the subject matter described in this disclosure can be implemented to realize one or more of the following potential advantages. By reducing the amount of material outgassed onto movable layers and adjacent surfaces, stiction between movable layers and adjacent surfaces with which the movable layers are brought into contact can be reduced. Because the sacrificial layers within the unreleased EMS devices protect these surfaces, a larger range of epoxy material and other sealing materials can be used. The quality of the seal can also be improved, by reducing or eliminating the pressure differential between the interior and exterior of the package that can arise from an epoxy bonding process. A self-assembled monolayer (SAM) can be used to coat the contact surfaces of EMS devices after release, but must be removed prior to the deposition of an epoxy seal to ensure adhesion between the epoxy seal and the substrate supporting the EMS devices. This removal process risks damaging components of the EMS devices, and reducing this risk can add additional cost and complexity to the manufacturing process. By performing the release etch after the after the backplate has been sealed to the supporting substrate to form the EMS package, the step of removing SAM material from the supporting substrate can be eliminated.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

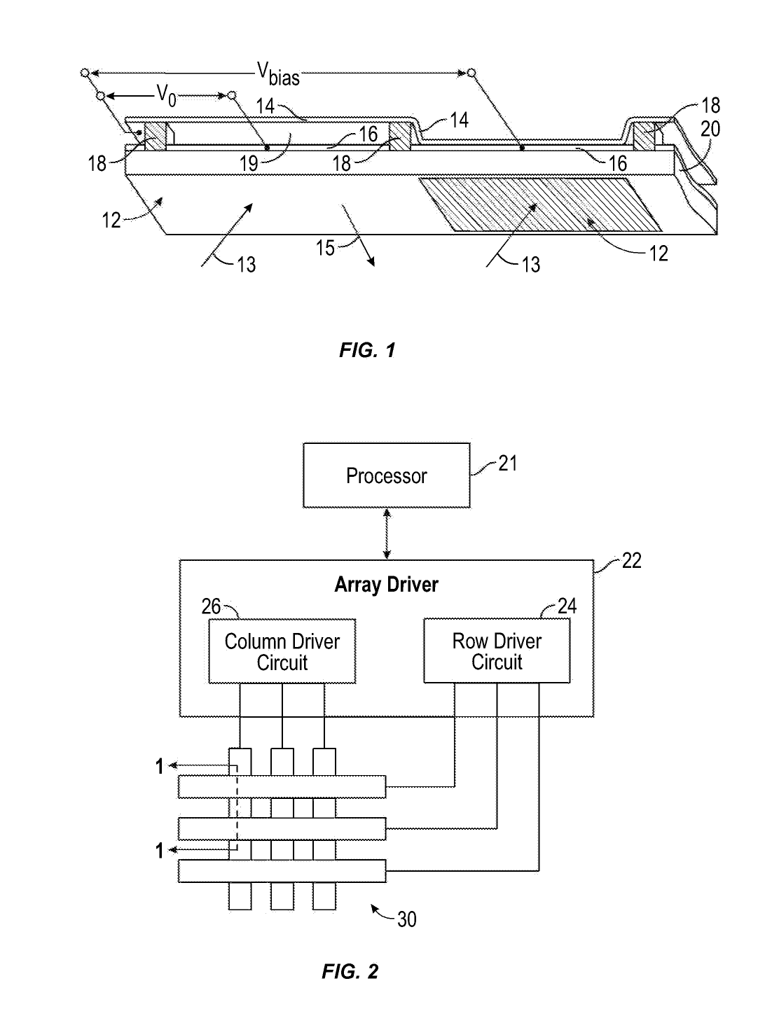

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

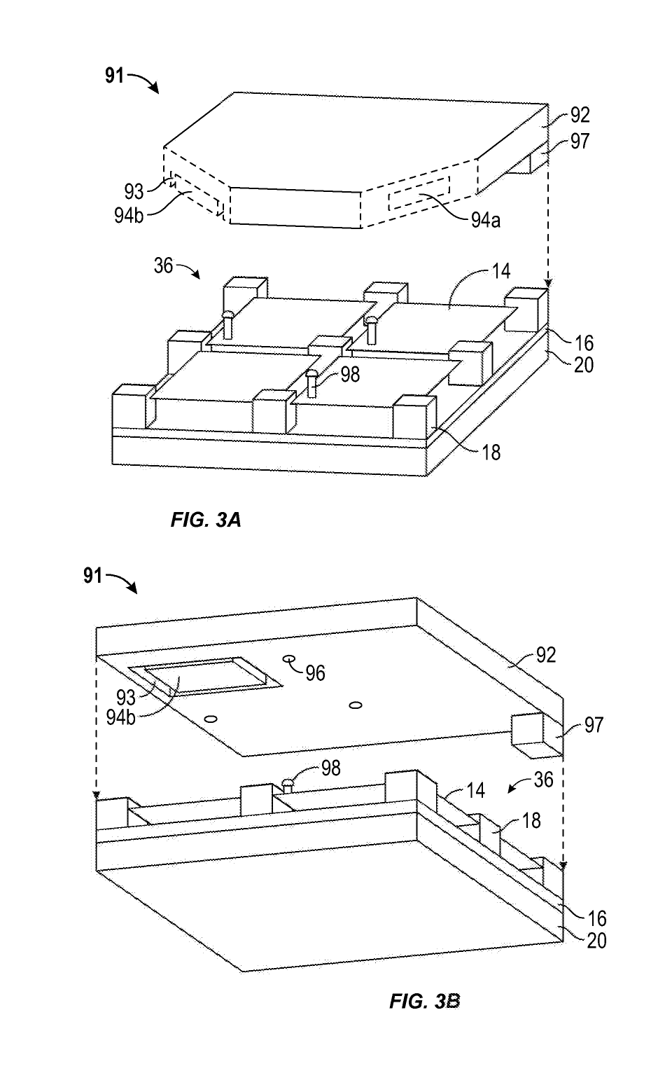

FIGS. 3A and 3B are schematic exploded partial perspective views of a portion of an EMS package 91 including an array 36 of EMS elements and a backplate 92. FIG. 3A is shown with two corners of the backplate 92 cut away to better illustrate certain portions of the backplate 92, while FIG. 3B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 3A and 3B, the backplate 92 can include one or more backplate components 94a and 94b, which can be partially or wholly embedded in the backplate 92. As can be seen in FIG. 3A, backplate component 94a is embedded in the backplate 92. As can be seen in FIGS. 3A and 3B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 3B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 3A and 3B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 3A and 3B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

During a fabrication process for an EMS device such as an IMOD, a movable layer may be formed by forming a sacrificial layer over an underlying layer, and subsequently forming the movable layer over the sacrificial layer. Upon removal of the sacrificial layer, the movable layer will be released. If the movable layer is to be electrostatically actuated, the movable layer may include at least one conductive layer, and the sacrificial layer may be disposed between the movable layer and a second conductive layer. In implementations in which the EMS device includes an IMOD, the movable layer may include a reflective layer, and the second conductive layer may include or be disposed adjacent an optical absorber.

In some implementations, the sacrificial layer may include a xenon difluoride (XeF₂)-etchable material such as molybdenum (Mo) or amorphous silicon (Si), in a thickness selected to provide, after subsequent removal, a gap or cavity (such as the cavity 19 of FIG. 1) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), spin-coating, or slit-coating. An etchable sacrificial material such as Mo or amorphous Si may be removed by dry chemical etching by exposing the sacrificial layer to a gaseous or vaporous etchant, such as vapors derived from solid XeF₂ for a period of time that is effective to remove the desired amount of material. The sacrificial material is typically selectively removed relative to the structures surrounding the cavity. Other etching methods, such as wet etching and/or plasma etching, also may be used.

The movable layer (such as the movable reflective layer 14 illustrated in FIG. 1) may include a reflective material such as such as aluminum, aluminum alloy, or another reflective materials, deposited over the sacrificial layer, and may be patterned to form individual movable layers within an array of EMS devices. In some implementations, the movable layer may include a plurality of sub-layers with one or more of the sub-layers including highly reflective sub-layers selected for their optical properties, and one or more of the other sublayers including a mechanical sub-layer, such as a dielectric material, selected for its mechanical properties. After removal of the sacrificial material, the resulting fully or partially fabricated EMS device may be referred to herein as a “released” EMS device.

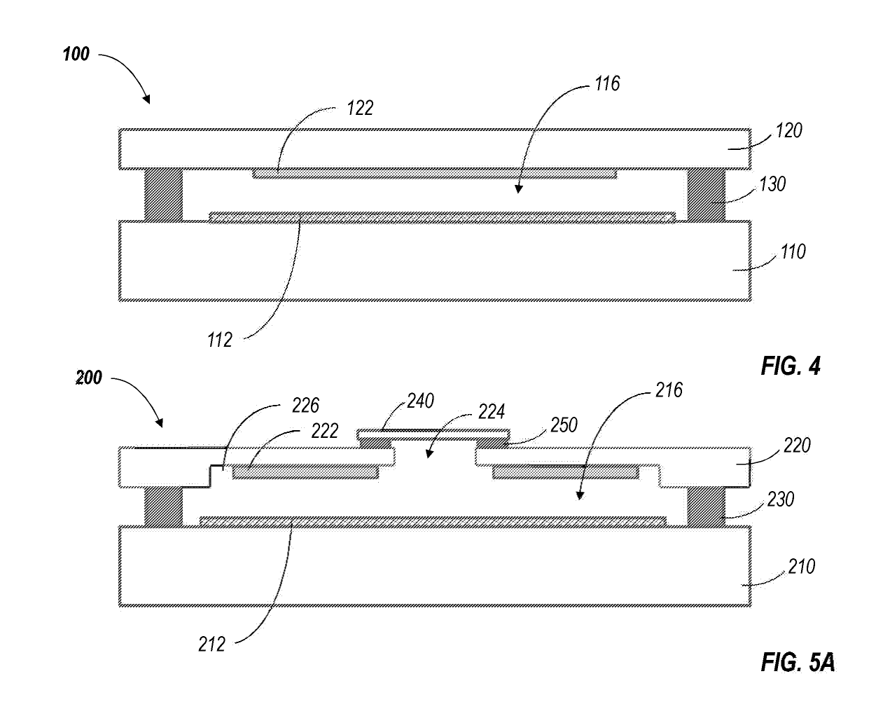

FIG. 4 is a schematic cross-section view of an example of an EMS package including an array of interferometric modulators (IMODs). In some implementations, an EMS package 100 may be formed after a release etch has been performed to release an array 112 of IMODs supported by a substrate 110. After performing the release etch, the EMS package 100 has been formed by sealing a backplate 120 to the substrate 110 via a seal 130 which circumscribes the IMOD array 112. The IMOD array 112 is thus located within a protective cavity 116 formed by the backplate 120, the supporting substrate 110, and the seal 130. The EMS package 100 protects the IMOD array 112 from both environmental and mechanical interference, and may include a layer of desiccant 122 within the cavity 116. However, in some implementations the sealing of the EMS package 100 after release of the IMOD array 112 can adversely affect the integrity of both the package 100 and the IMOD array 112 itself.

If the seal is formed from an epoxy or another sealant which will outgas materials as the seal is cured, the outgassing of materials into the cavity 116 can result in outgassed materials coating exposed surfaces of the IMODs within the IMOD array 112. The accumulation of outgassed materials on exposed surfaces of the IMODs which will be brought into contact with other surfaces of the IMODs can lead to failure of the IMODs due to stiction between these surfaces. The inclusion of a desiccant 122 or other adsorbing material within the cavity 116 can reduce this accumulation of outgassed materials, but at least some of the outgassed material will be deposited on the surfaces of the IMODs before being adsorbed.

In addition, the outgassing of sealant materials can lead to a pressure differential between the interior of the EMS package 100 and the ambient pressure outside the EMS package 100. The pressure within the cavity 116 can increase from the outgassing of sealant materials, as well as from the application of force to press the substrate 110 and the backplate 120 together after the seal 130 makes initial contact with both 110 and 120. After the substrate 110 and the backplate 120 have been pressed together, the pressure difference between inside the cavity 116 and the outside will push the backplate 120 away from the substrate 110 and may pull the seal 130 partially away from the backplate 120 or the substrate 110 before the sealant is completely cured. Because the seal 130 may peel partially away from the backplate 120 or the substrate 110 during or after the curing process, the narrowed portion of seal 130 at the area where the seal 130 is pulled away from the backplate 120 or substrate 110 may provide less protection than a more firmly secured seal 130. The narrowed seal 130 may also be more susceptible to failure over time during use of the EMS package 100.

In addition, ultraviolet (UV) light can be used to cure or accelerate the curing of certain epoxies and other sealing materials. In some implementations, such as where the IMODs of array 112 include multi-state or analog IMODs configured to be driven between a plurality of states to reflect different colors at each state, the IMOD array 112 may include associated thin-film transistors (TFTs) used in controlling the state of the multi-state or analog IMODs. Exposure of the released IMOD array 112 to UV light during the curing process can damage or adversely impact the TFTs in the array.

Furthermore, IMODs and other EMS devices which include contact surfaces may utilize a self-assembled monolayer (SAM) coating to reduce friction and/or stiction. The SAM coating must be applied after a release etch exposes the contact surfaces of the IMODs or other EMS devices, and the SAM coating will cover the areas of substrate 110 surrounding the IMOD array 112. To ensure a resilient seal between the material of seal 130 and the substrate 110, the residual SAM material on substrate 110 must be removed in the area in which the seal 130 will be located. This removal can involve the use of a UV light source, which can damage components within or adjacent the IMOD array 112. Other removal techniques can be used which have less risk of damage to the IMOD array 112, such as dry etching processes, but the use of such techniques can further increase the cost and/or complexity of the fabrication process.

In some implementations, the backplate 120 may be sealed to the substrate 110 prior to a release etch which releases the IMOD array 112, and the release etch performed after the initial sealing process. The release etch may be performed through one or more apertures which can be subsequently sealed. By leaving at least some sacrificial material in place during the formation of the primary seal sealing the backplate 120 to the substrate 110, the IMOD array 112 can be protected from at least some of the outgassed materials during the sealing process.

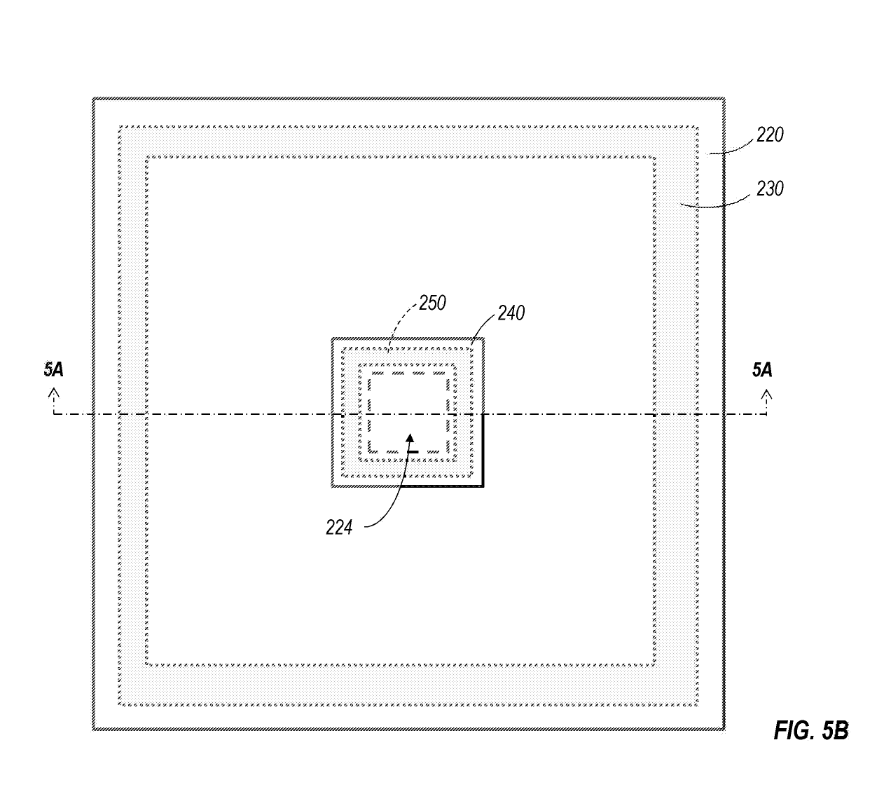

FIG. 5A is a schematic cross-section view of another example of an EMS package in which the backplate includes an aperture sealed by a cap. FIG. 5B is a top plan view of the EMS package of FIG. 5A. In FIG. 5A, it can be seen that a backplate 220 is sealed to a substrate 210 by a primary seal 230, encapsulating a released IMOD array 212 within a cavity 216. The backplate 220 includes a recess 226 and aperture 224 extending therethrough, and supports a layer of desiccant 222 disposed within the recessed area of recess 226. The inclusion of the recess 226 provides additional clearance for the underlying IMOD array 212 as well as for the desiccant 222, allowing the package 200 to be made thinner while still protecting the IMOD array 212.

The aperture 224 extending through the backplate 220 is sealed by a cap 240 overlying the aperture 224 and sealed to the outer surface of the backplate 220 by a secondary seal 250. In one implementation, the backplate 220 may be sealed to the substrate 210 by primary seal 230 before release of the IMOD array 212, while at least some sacrificial material used to define spacing between elements of the IMOD array 212 remains in place. A release etch may be performed through the open aperture 224 in the backplate 220, and the cap 240 may be used to seal the aperture 224 after the release etch has been performed to release the IMOD array 212. The secondary seal 250 sealing the cap 240 to the backplate 220 may be a solder material or any other suitable material, such as glass or metal.

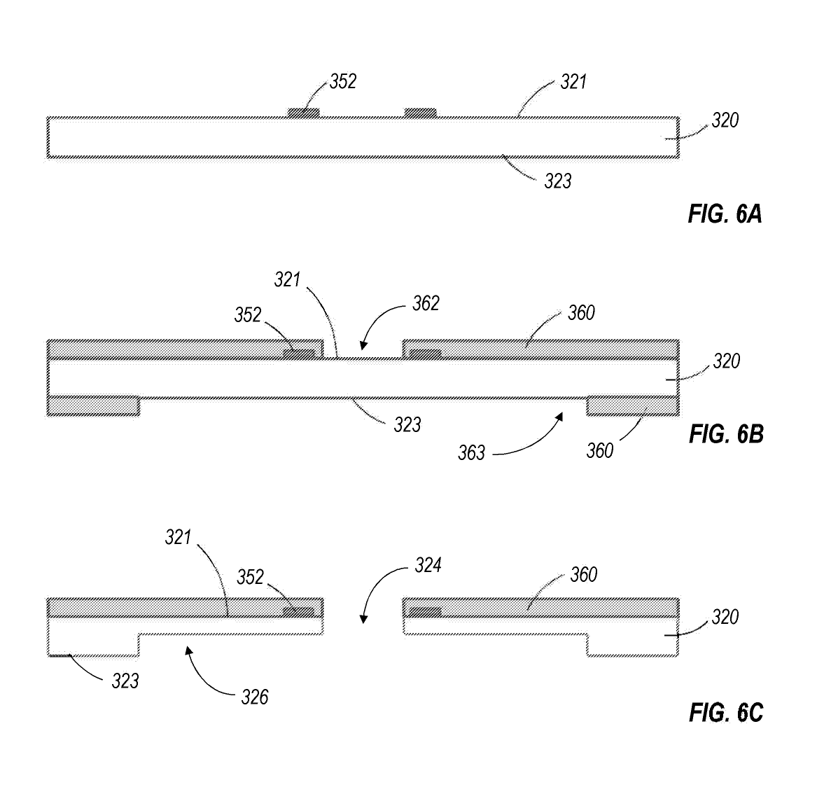

FIGS. 6A through 6C are schematic cross-sections of various stages in an example process for forming an etched backplate including an aperture. In FIG. 6A, a ring of wetting material 352 has been formed on a first surface 321 which will serve as the outer surface of the backplate 320 when sealed to another substrate to form a package. The wetting material 352 circumscribes a region of the backplate 320 in which an aperture will be formed.

In FIG. 6B, layers of protective material 360 have been formed on the first and second surfaces 321 and 323 of the backplate and patterned to form a first aperture 362 exposing a portion of the first surface 321 of the backplate 320 and a second aperture 363 exposing a portion of the second surface 323 of the backplate 320. The protective material 360 may be any material which is resistant to a hydrofluoric acid etch using a solution of hydrogen fluoride (HF) in water, or to any other etching chemistry which can be used to subsequently etch the backplate 320. The first aperture 362 exposes only a portion of the first surface 321 of the backplate 320 within the area circumscribed by the ring of wetting material 352. The second aperture 363 is larger than the first aperture 362 and has a footprint which extends beyond the edges of footprint of the first aperture 362 on all sides.

In FIG. 6C, an etching process has been used to etch the exposed portions 362 and 364 (see FIG. 6B) of the backplate 320. As noted above, this etching process may include a hydrofluoric acid etch, or any other suitable etching chemistry. The etching process is performed for a length of time sufficient for the etched portions to meet, forming a recess 326 in the second surface 323 of the backplate 320, and an aperture 324 which extends between the first surface 321 of the substrate and the back surface of the recess 326, forming a path which extends through an interior region of the backplate 320. In some implementations, the protective material 360 on the second surface 323 of the backplate 320 can be removed, while the protective material 360 on the first surface 321 of the backplate 320 can be left in place at this time to protect the wetting material 352. The backplate 320 can then be used in a fabrication process for forming an EMS package encapsulating an array of interferometric modulators or other devices as described below.

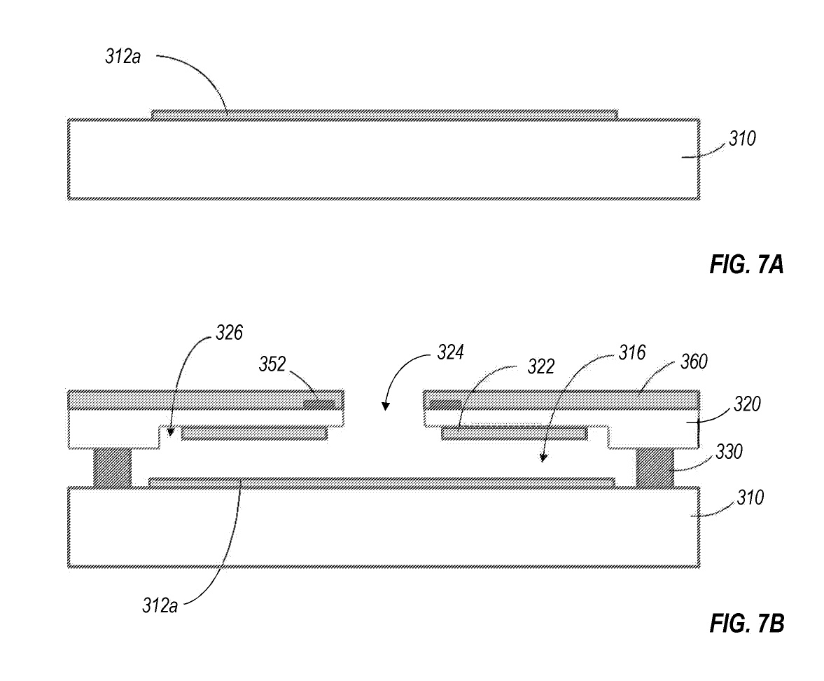

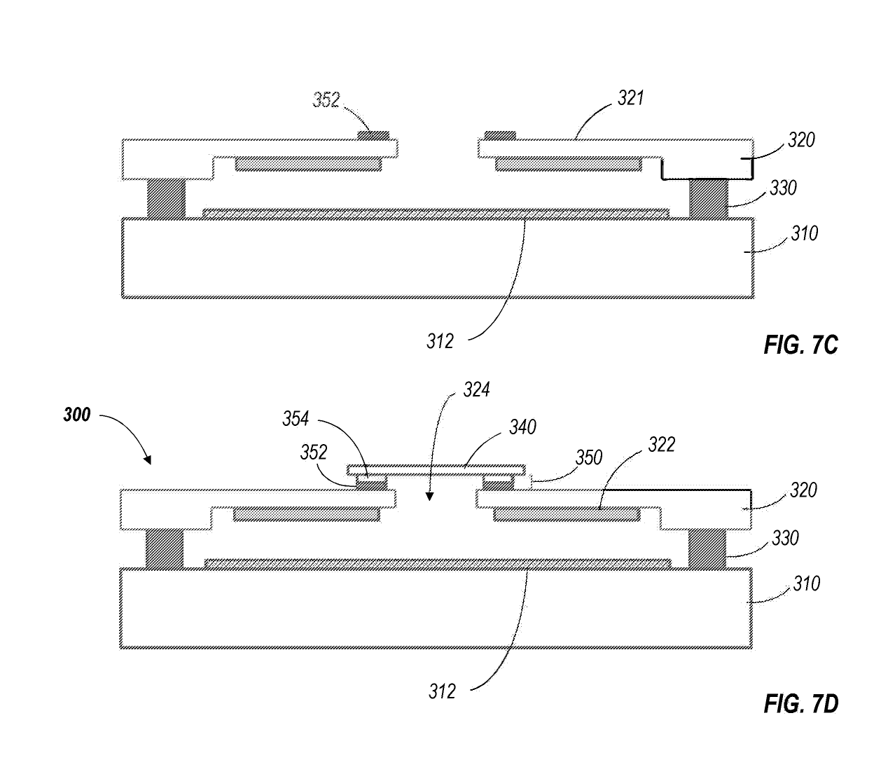

FIGS. 7A through 7E are schematic cross-sections of various stages in an example process for forming an EMS package including an aperture sealed by a cap. In FIG. 7A, an unreleased IMOD array 312a has been formed on a surface of substrate 310. Although the unreleased IMOD array 312a is referred to herein as unreleased, the unreleased IMOD array 312a may be partially released, with some sacrificial layers or material removed while some sacrificial layers or material remain in place. In other implementations, an array of other unreleased EMS devices may be formed on the substrate 310 and packaged as discussed herein.

In FIG. 7B, a backplate such as the backplate 320 of FIG. 6C is sealed to the substrate 310 by a seal 330 formed by a ring of sealing material. A cavity 316 is formed between the backplate 320 and the substrate 310 encapsulating the unreleased IMOD array 312a, with the aperture 324 extending between the exterior of the package and the cavity 316 within the interior of the package. In some implementations, a layer of desiccant material 322 can be applied within the recess 326 of the backplate 320 prior to sealing the backplate 320 to the substrate 310. The seal 330 may be cured at this time, while the IMOD array 312a remains unreleased. In some implementations, the seal 330 may be cured through exposure of the seal 330 to UV light, through exposure of the seal 330 to an elevated temperature, or by a pause in the fabrication process to allow the seal 330 to cure and/or outgas material over a period of time [0075] 0065] In FIG. 7C, a release etch has been performed to remove the remaining sacrificial material within unreleased IMOD array 312a (see FIG. 7B) to form a released IMOD array 312. The protective layer 360 (see FIG. 7B) extending over the outer surface 321 of the backplate 320 has also been removed to expose the wetting layer 352, either as part of the release etch or as a separate etch. This release etch may be performed after the seal 330 has been at least partially cured, so that the sacrificial material within the unreleased IMOD array 312a (see FIG. 7B) protects surfaces within the unreleased IMOD array 312a from being coated with outgassed material from the seal 330. In some implementations, the seal 330 may be fully cured, or sufficiently cured so that a reduced amount of material will be outgassed from the seal 330 over time.

In FIG. 7D, the aperture 324 has been sealed using a cap 340 to form a sealed EMS package 300. The cap 340 may be sealed to the backplate 320 using any suitable sealant, but in some implementations the cap 340 may be sealed by flowing a layer of solder material 354 over the wetting layer 352, and bringing the cap 340 into contact with the solder material 354. The combination of the wetting layer 352 and the solder material 354 forms a secondary seal 350. The cap 340 may be made from any suitable material, and in some implementations may include metal, ceramic, plastic, or glass, although other suitable materials may also be used.

In contrast to the formation of a seal 330 from an epoxy material or another resilient material, the soldering process used to form secondary seal 350 will not create a substantial pressure difference between the interior and exterior of the EMS package 300. In addition, the cap 340 may be used to seal the aperture 324 after the seal 330 has outgassed at least a portion of the material which will be outgassed from the seal 330 over time, reducing an additional or alternative source of pressure differential that may occur as the seal 330 outgasses material into the interior of the EMS package 300. By reducing pressure differential between the interior and exterior of the EMS package 300, the pressure pushing the backplate 320 away from the substrate 310 will be reduced, so that the seal 330 will be less likely to be pulled partially away from the backplate 320 or the substrate 310. In addition, the total amount of material outgassed into the interior of the sealed EMS package 300 can be reduced, reducing accumulation of such material on the surfaces of the IMOD array 312 contained within to reduce stiction and extend the lifetime of the IMOD array 312.

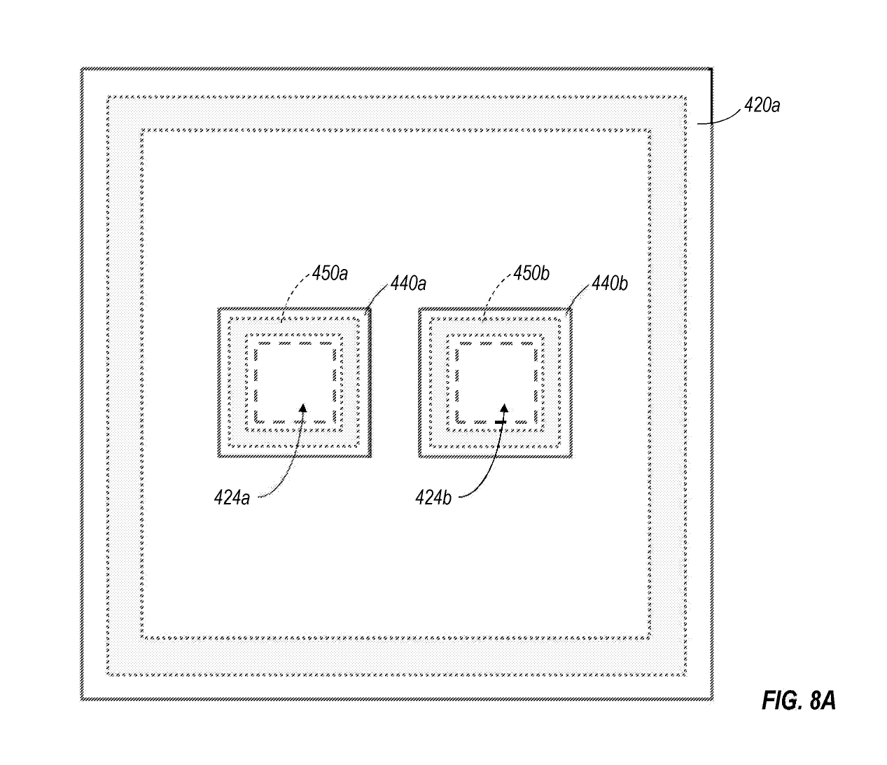

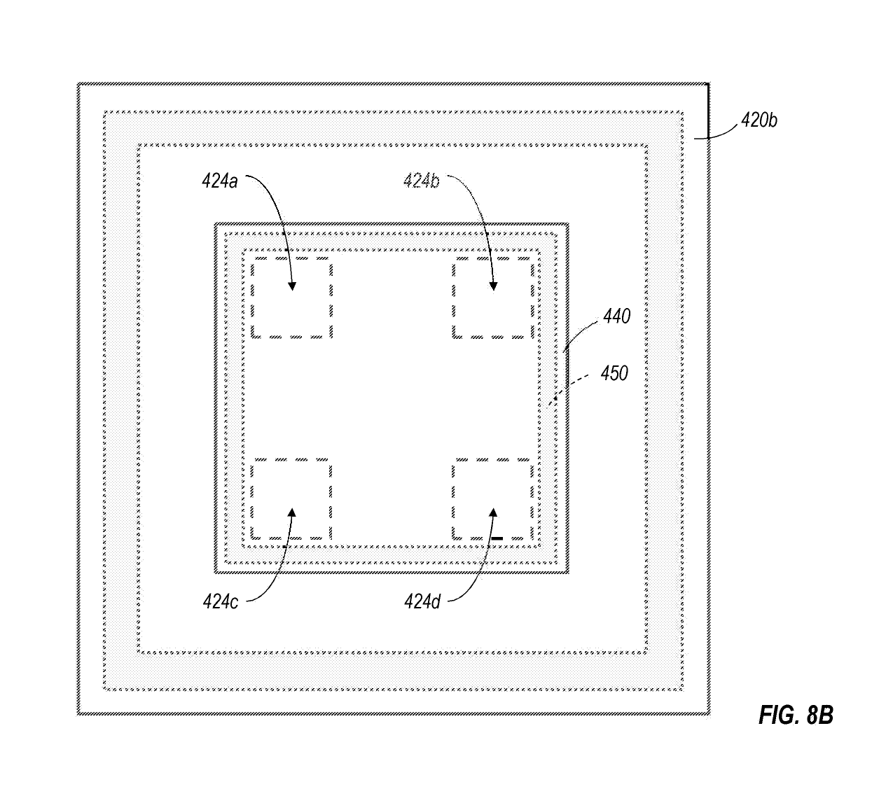

In some implementations, a backplate having more than one aperture extending therethough can be used. FIG. 8A is a top plan view of an example of a backplate with multiple apertures sealed by multiple caps. The backplate 420a includes a first aperture 424a and a second aperture 424b. A first secondary seal 450a extends around first aperture 424a and seals a first cap 440a in place over the first aperture 424a. A second secondary seal 450b extends around second aperture 424b and seals a second cap 440b in place over the second aperture 424b.

In some other implementations, a single cap can be used to seal multiple apertures. FIG. 8B is a top plan view of an example of a backplate with multiple apertures sealed by a single cap. The backplate 420b includes four apertures 424a, 424b, 424c, and 424d. A single secondary seal 450 extends around all four apertures 424a, 424b, 424c, and 424d, and seals a single cap 440 over all four apertures 424a, 424b, 424c, and 424d.

The use of multiple apertures can increase the effectiveness and uniformity of the release etch, as the release etchant can be introduced into the package at multiple locations. In addition, the use of multiple apertures can allow more efficient pumping of or outgassing of materials during the curing of the primary seal. Any suitable number of caps may be used to seal the plurality of apertures, in any suitable configuration. In implementations in which multiple secondary seals are used, multiple tracks of wetting material may be used to define the locations of the multiple secondary seals.

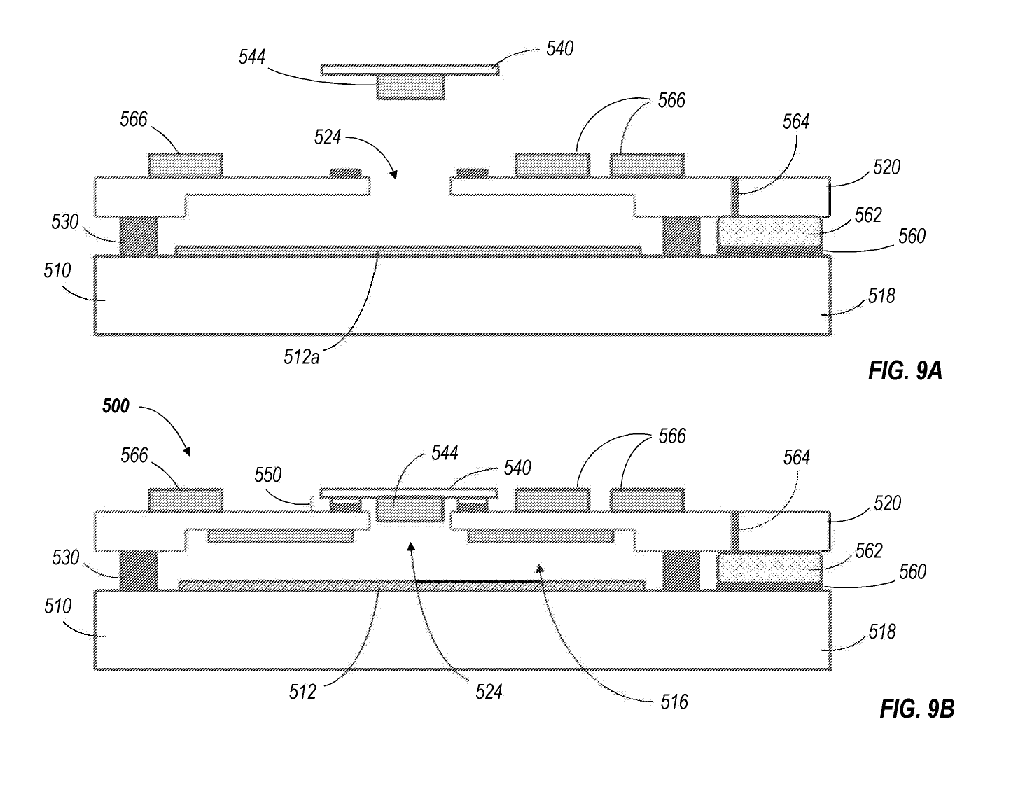

FIG. 9A is a schematic cross-section of an example of an EMS package which includes a circuit board as a backplate, shown in a partially unassembled state. In some implementations, a circuit board including a vapor barrier may be used as a backplate, and may also be used to support microchips used in controlling an array of IMODs or other components of a display device. The EMS package of FIG. 9A includes a backplate 520 formed from a circuit board including a vapor barrier. The backplate 520 is sealed by seal 530 to a substrate 510 supporting an unreleased IMOD array 512a. The backplate 520 also includes an aperture 524 extending therethrough and providing a path between the interior and the exterior of the EMS package. The cap 540 which will be used to seal the aperture 524 in backplate 520 can include a desiccant patch 544. The substrate 510 includes a lip 518 supporting conductive pads 560 at a location outside of the seal 530.

These conductive pads 560 can be in electrical communication with the IMOD array 512a, and can be used to provide connection to other components external to the interior of the EMS package. In the illustrated implementation, a section of anisotropic conductive film (ACF) 562 can be disposed between the backplate 520 and the conductive pads 560 and provide portions of one or more conductive paths between the unreleased IMOD array 512a and the circuit board of the backplate 520. In other implementations, soldering or another suitable technique can be used to form a conductive path between the unreleased IMOD array 512a and the circuit board of the backplate 520. Conductive vias 564 extending through the backplate 520 can be used as a portion of conductive paths between the unreleased IMOD array 512a and microchips 566 supported by the backplate 520. Electrical traces on and/or within the circuit board of backplate 520 can provide other sections of the conductive paths between the unreleased IMOD array 512a and microchips 566.

FIG. 9B is a schematic cross-section of the EMS package of FIG. 9A, shown in an assembled state. The IMOD array 512 has been released by a release etch, and cap 540 has subsequently been sealed to the backplate 520 by a secondary seal 550 to seal aperture 524 and form a sealed EMS package 500. The desiccant patch 544 supported by cap 540 is exposed to the interior cavity 516 of the EMS package 500 and can adsorb moisture or outgassed contaminants over the lifetime of the device. By placing the desiccant patch 544 on the cap 540, the desiccant patch 544 can avoid exposure to outgassed materials during the curing process of seal 530, potentially increasing the useful lifetime of the desiccant patch 544 and extending the lifetime of the IMOD array 512.

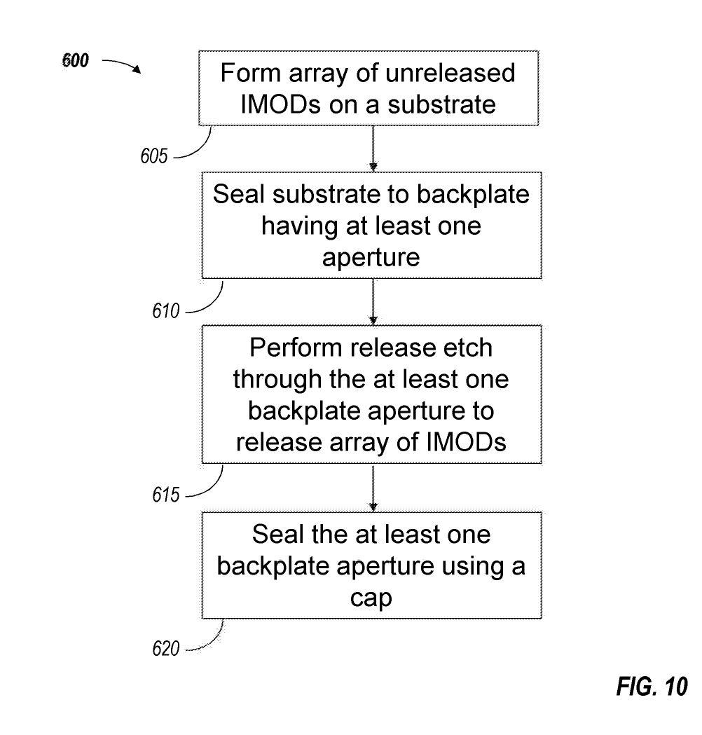

FIG. 10 is a flow diagram illustrating a fabrication process for an EMS package which utilizes a post-encapsulation release etch. The process 600 begins at a stage 605 where an array of unreleased IMODs is formed on a substrate. The IMODs may in some implementations be partially released, as discussed above. The array of IMODs may also include a plurality of TFTs which may be used in controlling the state of the array of IMODs, and in certain implementations, may be used in controlling the state of IMODs in an analog or multistate manner. In other implementations, any other suitable type of EMS devices can be formed on the substrate.

The process then moves to a stage 610, where a backplate having at least one aperture formed therein is sealed to the substrate by a primary seal. In some implementations, the seal may be an epoxy material, and may in particular be a thermally-cured epoxy material or a UV-cured epoxy material. In an implementation in which the epoxy material is a thermally-set epoxy material, this curing process can include exposing the epoxy material to heat. In an implementation in which the epoxy material is a UV-cured epoxy material, this curing process can include exposing the epoxy material to UV light. The sealing material of the primary seal may be allowed to cure and outgas material through the aperture in the backplate while the array of IMODs remains in an unreleased state, protecting the array of IMODs from being affected by the outgassed material. The backplate may be a circuit board including a vapor barrier, as discussed above. The backplate may include microchips or other electronic circuitry, and one or more electrical connections may be formed between the backplate and the array of IMODs using an anisotropic conductive material or any other suitable method.

The process then moves to a stage 615, where a release etch is performed through the aperture in the backplate to release the array of IMODs. The release etch may be performed after the primary seal has been at least partially cured, to reduce exposure of the IMOD array to outgassed material from the seal.

process then moves to a stage 620, where a cap is sealed to the backplate by a secondary seal to seal the aperture in the backplate. In some implementations, the cap may be sealed to the backplate by a solder material, which can be flowed onto a ring of wetting material circumscribing the aperture in the backplate.

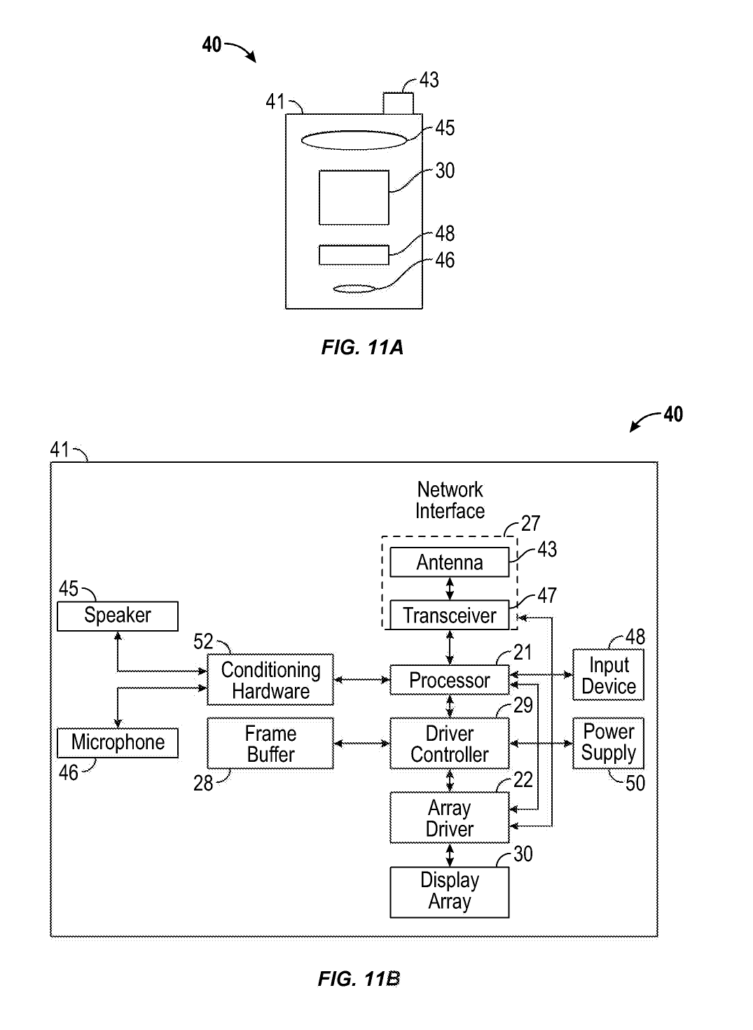

Some implementations of the EMS package including an array of IMODs described above may form part of a display device. FIGS. 11A and 11B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 11A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device, comprising
a substrate;
an array of interferometric modulators supported by a first surface of the substrate;
a backplate sealed to the substrate by a first seal circumscribing the array of interferometric modulators to form a cavity surrounding the array of interferometric modulators, the backplate including at least one aperture extending through the backplate; and
at least one cap overlying the at least one aperture in the backplate and sealed to the backplate by at least a second seal circumscribing the aperture.

2. The device of claim 1, wherein the backplate includes a first surface facing the array of interferometric modulators and a second surface on the opposite side of the backplate as the first surface, and wherein the cap is sealed to the second surface of the backplate by the at least one second seal.

3. The device of claim 1, wherein the backplate includes at least a second aperture extending through the backplate.

4. The device of claim 3, wherein the at least one cap extends over at least the first and second apertures extending through the backplate.

5. The device of claim 4, wherein the second seal circumscribes at least the first and second apertures extending through the backplate.

6. The device of claim 3, additionally including at least a second cap overlying the second aperture extending through the backplate and sealed to the backplate by a third seal circumscribing the second aperture.

7. The device of claim 1, wherein the cap supports a desiccant patch, and wherein the desiccant patch is aligned with the at least one aperture in the backplate.

8. The device of claim 1, wherein the first seal includes epoxy.

9. The device of claim 1, wherein the second seal includes metal or glass.

10. The device of claim 1, further comprising a plurality of thin-film transistors (TFTs) located between the substrate and the backplate.

11. The device of claim 10, wherein the plurality of TFTs are capable of controlling the state of the array of interferometric modulators.

12. The device of claim 1, wherein the backplate is a printed circuit board including a vapor barrier.

13. The device of claim 12, wherein the printed circuit board supports at least one microchip, wherein the at least one microchip is in electrical communication with the array of interferometric modulators.

14. The device of claim 13, wherein an anisotropic conducting film located between the substrate and the backplate is in electrical communication with both of the array of interferometric modulators and the at least one microchip.

15. The device of claim 1, additionally including:
a processor that is configured to communicate with the array of interferometric modulators, the processor being configured to process image data; and
a memory device that is configured to communicate with the processor.

16. The device of claim 15, additionally including:
a driver circuit configured to send at least one signal to the display; and
a controller configured to send at least a portion of the image data to the driver circuit

17. The device of claim 15, additionally including an image source module configured to send the image data to the processor, wherein the image source module comprises at least one of a receiver, transceiver, and transmitter.

18. The device of claim 15, additionally including an input device configured to receive input data and to communicate the input data to the processor

19. A device, comprising
a substrate;
an array of interferometric modulators supported by a first surface of the substrate;
a backplate sealed to the substrate by a first seal circumscribing the array of interferometric modulators to form a cavity surrounding the array of interferometric modulators, the backplate including means for introducing a release etchant into the cavity after sealing the backplate to the substrate;
at least one cap overlying the introducing means; and
means for sealing the cap to the backplate, the sealing means circumscribing the introducing means.

20. The device of claim 19, wherein the introducing means includes at least one aperture extending through the backplate, wherein the sealing means includes at least a second seal, and wherein the second seal circumscribes the aperture.

21. The device of claim 19, wherein the introducing means includes a plurality of apertures extending through the backplate.

22. The device of claim 21, wherein the cap overlies only one of the plurality of apertures, and wherein the sealing means includes at least a second seal, the device additionally including:
at least one additional cap overlying at least a second of the plurality of apertures extending through the backplate; and
at least a third seal circumscribing at least the second of the plurality of apertures extending through the backplate.

23. The device of claim 21, wherein the cap overlies all of the plurality of apertures.

24. A method of fabricating an EMS device, the method comprising:
forming an array of unreleased interferometric modulators supported by a first surface of a substrate;
sealing a backplate to the substrate by a first seal circumscribing the array of interferometric modulators to form a cavity surrounding the array of interferometric modulators, the backplate including at least one aperture extending through the backplate;
performing a release etch to release the array of interferometric modulators by introducing an etchant through the at least one aperture extending through the substrate; and
sealing a cap to the backplate by a second seal to seal the at least one aperture extending through the substrate.

25. The method of claim 24, wherein the backplate includes a ring of wetting material circumscribing the at least one aperture extending through the backplate, and wherein sealing the cap to the backplate includes flowing a solder material onto the ring of wetting material.

26. The method of claim 24, wherein the first seal includes an epoxy material, the method additionally including curing the epoxy material of the first seal by exposing the epoxy material to heat prior to performing the release etch.

27. The method of claim 24, wherein the first seal includes an epoxy material, the method additionally including curing the epoxy material of the first seal by exposing the epoxy material to ultraviolet (UV) light prior to performing the release etch.
